(19) United States
(12) Patent Application Publication
(10) Pub. No.: US 2020/0378815 A1
(43) Pub. Date: Dec. 3, 2020

(54) SOLID LEVEL MEASUREMENT WITH VIBRATING ROD SENSORS

(71) Applicant: Baker Hughes Oilfield Operations LLC, Houston, TX (US)

(72) Inventors: Lily Jiang, Oklahoma City, OK (US); Jason Angolano, Oklahoma City, OK (US); Sam Stroder, Oklahoma City, OK (US); Gregory Adams, Oklahoma City, OK (US)

(73) Assignee: Baker Hughes Oilfield Operations LLC, Houston, TX (US)

(21) Appl. No.: 16/888,725

(22) Filed: May 30, 2020

Related U.S. Application Data
(60) Provisional application No. 62/854,655, filed on May 30, 2019.
(60) Provisional application No. 62/947,671, filed on Dec. 13, 2019.

(51) Int. Cl. G01F 23/22; E21B 43/34; B01D 21/26; B01D 21/24; B01D 21/34

(52) U.S. Cl. CPC G01F 23/22; E21B 43/34; B01D 21/34; B01D 21/2411; B01D 21/267

(57) ABSTRACT

A system for determining the level of solids accumulated in a sand separator has a vibratory level sensor and a solid separator control system. The vibratory level sensor includes a vibratory rod and an exciter connected to the vibratory rod. In some embodiments, a vibration sensor is connected to the vibratory rod to monitor changes in the vibration of the rod. In other embodiments, changes in vibration are measured by looking at the rotational speed and power inputs at the exciter.

### RELATED APPLICATIONS

This application claims the benefit of U.S. Provisional Patent Application Ser. No. 62/854,655 filed May 30, 2019 entitled “Solid Level Measurement with Vibrating Rod Sensors,” and U.S. Provisional Patent Application Ser. No. 62/947,671 filed Dec. 13, 2019 entitled “Solid Level Measurement with Vibrating Rod Sensors,” the disclosures of which are herein incorporated by reference.

### FIELD OF THE INVENTION

This invention relates generally to the field of oil and gas production, either onshore or offshore, and more particularly to the monitoring and control of surface-based solid separation systems. This invention can be used also in other industries other than oil and gas, for example mining, food, livestock, etc.

### BACKGROUND

When the well is flowing, proppant, sand, fines and other particulate solids often come up out of the well with produced hydrocarbons. Sand separators are used to prevent the solids from entering downstream sales lines, storage facilities and processing equipment.

A PRIOR ART sand separator 200 is illustrated in FIG. 1. The sand separator 200 is connected between a wellhead 202 and a phase separator 204. Although a choke 206 may be placed between the wellhead 202 and the sand separator 200 to moderate the pressure of the inlet slurry, conventional sand separators 200 are nonetheless rated to very high pressures. The high pressure slurry of liquid, gas and solids discharged from the wellhead 202 is passed through the choke 206 to the sand separator 200, where the slurry is forced into cyclonic rotation. The rotation of the multiphase slurry within the sand separator 200 encourages heavier solid particles to fall to the bottom of the sand separator 200 while lighter fluids are discharged from the top of the sand separator 200 to the downstream phase separator 204.

The level of solids in the sand separator 200 increases during use. To maintain the efficient and safe operation of the sand separator 200, it is necessary to periodically dump the accumulated solids by opening a dump valve 208 connected to the bottom of the sand separator 200. When the dump valve 208 is opened, the solid particles are pushed out of the sand separator 208 into a frac tank (not shown) for reuse or into other downstream storage or disposal facilities.

A significant complication with the operation of the sand separator 200 is determining when the accumulated solids should be dumped from the sand separator 200. In the past, the removal of solids from the sand separator 200 would take place on scheduled intervals, or according to the operator's judgment based on highly subjective measurements. In many cases, operators listen for changes in the sounds coming from the sand separator 200 to determine when to open the dump valve 208. These subjective evaluation techniques can lead to inefficient operating conditions that lead to a need of level sensor to measure solid level of separator. The development of effective level sensors is frustrated by several challenges, including the high operating pressures and the corresponding heavy wall thickness used for the sand separators.

Recently, manufacturers have outfitted sand separators with electronic sensors that attempt to determine the level of sand inside the sand separator 200. Load cell strain gages are installed on the exterior of the sand separator 200 and configured to measure the weight of the sand separator 200. Load cell strain gages often inaccurately evaluate the quantity of sand in the sand separator 200 because the load cell cannot discern if added weight is attributable to solids or liquids inside the sand separator 200. In other cases, manufacturers have deployed tuning fork sensors inside the sand separator 200 for evaluating the shift between liquid and solids. Tuning fork sensors are generally effective at detecting the interface of solids and liquids inside the sand separator 200, but these sensors are incapable of determining the quantities of solids trapped inside the sand separator 200. There is, therefore, a need for an improved sensor system that more rapidly and accurately measures the level of solids trapped in a sand separator.

### SUMMARY OF THE INVENTION

In one aspect, embodiments of the present invention include a system for determining the level of solids accumulated in a sand separator. The system has a vibratory level sensor and a solid separator control system. The vibratory level sensor includes a vibratory rod, an exciter connected to the vibratory rod, and a vibration sensor connected to the vibratory rod. The solid separator control system has a data library of correlations between vibration sensor measurements and solid volumes inside the sand separator.

In another aspect, the present invention includes a method for determining the level of accumulated solids within a sand separator that includes a vibratory level sensor. The method includes the steps of providing a pressurized slurry of solids and fluids to the sand separator, activating an exciter on the vibratory level sensor to induce an initial frequency in a vibratory rod of the vibratory level sensor, separating the solids from the fluids inside the sand separator such that the solids settle toward the bottom of the sand separator in contact with the vibratory rod, measuring a change in the vibration frequency of the vibratory rod with a vibration sensor, and determining the weight or volume of solids in the sand separator based on the measured change in the vibration frequency of the vibratory rod.

In another aspect, embodiments of the present invention include a system for determining the level of solids accumulated in a sand separator. The system has a vibratory level sensor and a solid separator control system. The vibratory level sensor includes a vibratory rod and an exciter connected to the vibratory rod. The solid separator control system has a data library of correlations between changes in the rotational speed of the motor and solid volumes inside the sand separator.

In yet another aspect, a method for determining the level of accumulated solids within a separator includes the steps of providing a pressurized slurry of solids and fluids to the separator, activating an exciter on the vibratory level sensor by applying power to a motor that rotates an eccentric mass to induce an initial frequency in a vibratory rod of the vibratory level sensor, separating the solids from the fluids inside the separator such that the solids settle toward the bottom of the separator in contact with the vibratory rod, measuring a change in the rotational speed of the motor, and determining the level of solids in the sand separator based on the measured change in the rotational speed of the motor.

### BRIEF DESCRIPTION OF THE DRAWINGS

FIG. 1 is a depiction of a PRIOR ART sand separator.

FIG. 2 is a depiction of a sand separator with a plurality of vibratory level sensors.

FIG. 3 is a depiction of a vibratory level sensor and control system constructed in accordance with a first embodiment.

FIG. 4 is a cross-sectional view of the vibratory level sensor of FIG. 3.

FIG. 5 is a close-up cross-sectional view of a portion of the vibratory level sensors of FIGS. 4 and 9 installed on a sand separator.

FIG. 6 is a graph of vibration frequencies recorded by the vibratory level sensor of FIG. 4 over time.

FIG. 7 is a graph showing the attenuation of frequencies recorded by the vibratory level sensor of FIG. 4 over time.

FIG. 8 is a depiction of a vibratory level sensor and control system constructed in accordance with a second embodiment.

FIG. 9 is a cross-sectional view of the vibratory level sensor of FIG. 8.

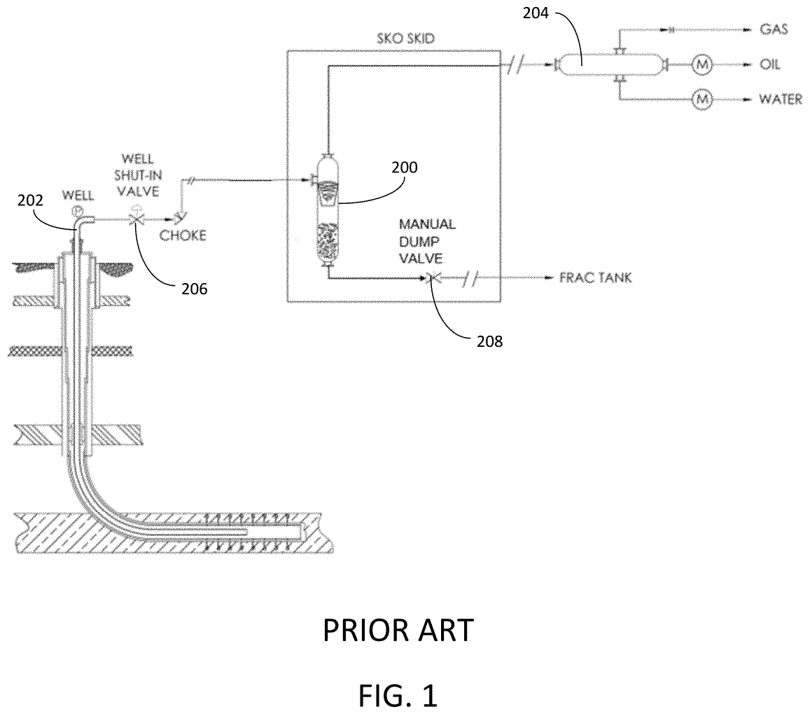

### WRITTEN DESCRIPTION

As used herein, the term “petroleum” refers broadly to all mineral hydrocarbons, such as crude oil, gas and combinations of oil and gas. The term “fluid” refers generally to both gases and liquids, and “two-phase” or “multiphase” refers to a fluid that includes a mixture of gases and liquids. It will be appreciated by those of skill in the art that in the downhole environment, such fluids may also carry entrained solids and suspensions. Accordingly, as used herein, the terms “two-phase” and “multiphase” are not exclusive of fluids that may also contain liquids, gases, solids, or other intermediary forms of matter.

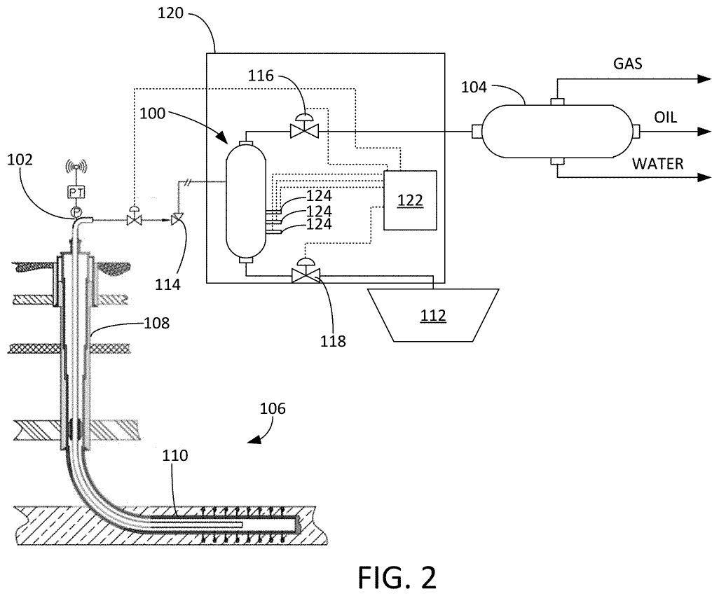

FIG. 2 depicts a sand separator 100 connected between a wellhead 102 and a multiphase separator 104. The wellhead 102 is above a well 106, which is drilled for the production of hydrocarbons. The well 106 may include a vertical portion 108 and a lateral portion 110. The well 106 have been hydraulically fractured in one or more stages to increase the production of hydrocarbons from the surrounding producing formations. The well 106 produces a mixture of hydrocarbons (both liquid and gas), water, and solids. The solids may include proppants, sand, fines, cuttings and other particles originating from the well 106.

The wellbore fluids and entrained solids are carried from the wellhead 102 to the sand separator 100, where the lighter liquids and gases are separated from the heavier solids. The liquids and gases are passed from the upper portion of the sand separator 100 to the multiphase separator 104, where gases, hydrocarbon liquids and water-based liquids are separated and routed to downstream storage, disposal or sales lines. Solids trapped by the sand separator 100 are periodically discharged from the lower portion of the sand separator 100 to a solids tank 112 for disposal, refinement or reuse. The sand separator 100 may employ a conventional cyclonic separation mechanism in which a vortex is formed inside the sand separator 100 by the tangential introduction of the high pressure well stream into the cylindrical sand separator 100.

A choke 114 is positioned between the sand separator 100 and the wellhead 102. The choke 114 can be manually or automatically adjusted to control the flow of liquids, gases and solids produced from the well 106. A back pressure regulator 116 is positioned between the sand separator 100 and the multiphase separator 104 to manually or automatically control the pressure and flow of fluids discharged from the sand separator 100 to the multiphase separator 104. A dump valve 118 is positioned between the sand separator 100 and the solids tank 112. The dump valve 118 can be manually or automatically opened and closed to discharge accumulated solids from the sand separator 100 to the solids tank 112.

In some embodiments, the sand separator 100 is deployed on a sand separator skid 120. The sand separator 100 can be deployed in connection with a solid separator control system 122 that automates some or all of the operation of the sand separator 100. The solid separator control system 122 interfaces with the sand separator 100, the dump valve 118, the choke 114 and the back pressure regulator 116 to optimize the operation of the sand separator 100. The solid separator control system 122 can be configured to adjust the choke 114 and the back pressure regulator 116 to optimize the inlet pressure, discharge pressure, pressure drop and flow rates through the sand separator 100. The solid separator control system 122 can also be configured to monitor the level of solids trapped in the sand separator 100, determine that a threshold level has been reached, and open the dump valve 118 to discharge solids into the solids tank 112. It will be appreciated that the solid separator control system 122 can be connected to additional sources of information, including well control systems, pressure sensors, temperature sensors, vibration sensors, level sensors, and flowrate sensors, which may be installed on or near the sand separator 100, the sand separator skid 120, the well 106, the wellhead 102, the solids tank 112, the multiphase separator 104 and accompanying equipment and piping.

In exemplary embodiments, the sand separator 100 includes one or more vibratory level sensors 124 (three are depicted in FIG. 2). Each vibratory level sensor 124 is configured to accurately determine the volume and placement of solids trapped in the sand separator 100. As depicted in FIG. 2, the sand separator 100 may include multiple vibratory level sensors 124 disposed at different depths and positional orientations within the sand separator 100 to provide measurements of the level of solids throughout the sand separator 100.

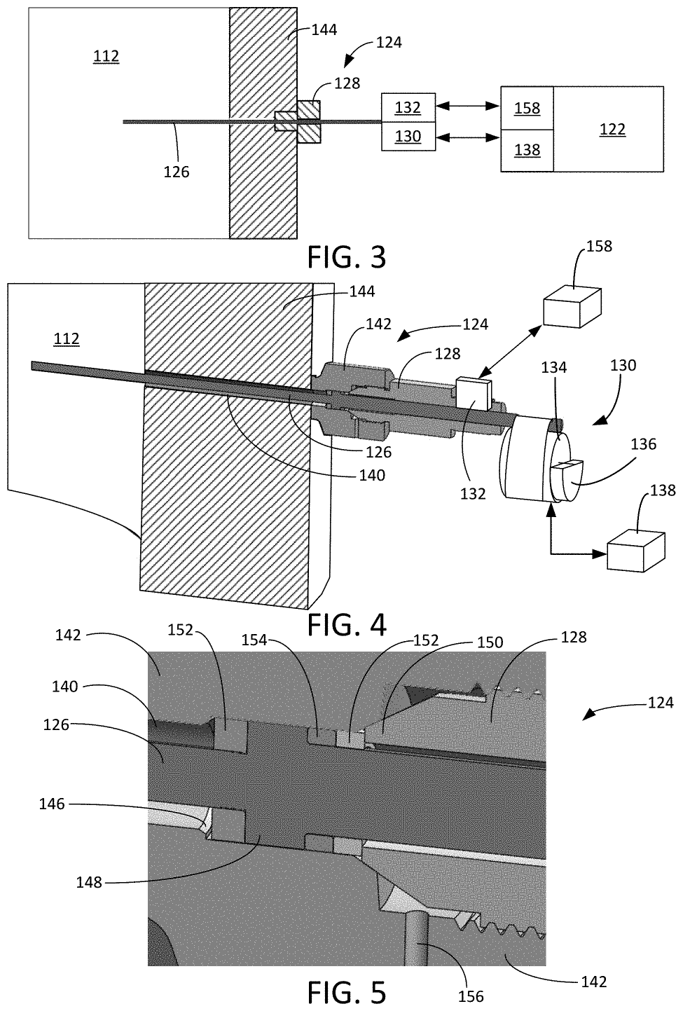

Turning to FIGS. 3-5, shown therein a various depictions of a first embodiment of the vibratory level sensor 124. In this embodiment, the vibratory level sensor 124 includes a rod 126, a pressure fitting 128, an exciter 130 and a vibration sensor 132. The rod 126 can be manufactured from stainless steel or other metal that is abrasion-resistant and offers a desirable and predictable response to vibrations from the exciter 130. As described herein, the “distal” end of the rod 126 is located inside the sand separator 100, while the “proximal” end of the rod 126 is located outside the sand separator 100.

The exciter 130 is a powered component that is coupled or connected to the proximal end of the rod 126. In some embodiments, the exciter 130 includes a motor 134, an eccentric mass 136 and a motor controller 138. When activated in response to a command signal from the motor controller 138, which may be integrated within the exciter 130 or within the sand separator control system 122, the motor 134 rotates that eccentric mass 136 at a selected speed to induce a vibration at a selected frequency in the rod 126.

The pressure fitting 128 retains the rod 126 within the sand separator 100. The rod 126 of the vibratory level sensor 124 is installed through a sensor bore 140 that extends from a sensor holder 142 through a vessel side wall 144 of the sand separator 100 to the interior of the sand separator 100. The sensor holder 142 may be welded to the external surface of the sand separator 100 using fittings available under the Weldolet trademark. The sensor bore 140 has an inner diameter that is larger than the outer diameter (or cross-sectional dimensions) of the rod 126 so that the rod 126 is not in direct contact with the vessel side wall 144. The sensor bore 140 and rod 126 can be installed horizontally through the vessel side wall 144, vertically through the bottom or top of the sand separator 100, or at a declined angle through the vessel side wall 144. Orienting the sensor bore 140 and the rod 126 at a declined angle through the vessel side wall 144 encourages solid particles caught in the sensor bore 140 to be expelled by gravity from the sensor bore 140. In some embodiments, the vibratory level sensor 124 and solid separator control system 122 are configured to carry out a cleaning cycle in which the vibration sensor 132 is temporarily disregarded and the rod 126 is actuated to forcefully expel solid particles from the sensor bore 140. The cleaning cycle can be performed on a periodic basis or as needed in response to detection of excess solid particles in the sensor bore 140.

As best seen in FIG. 5, the sensor bore 140 narrows includes a narrowing throat 146 and the rod 126 includes a shoulder 148. The internal insertion of the rod 126 is stopped by the throat 146 of the sensor bore 140. The pressure fitting 128 is optimally configured for a threaded engagement with the sensor holder 142. The pressure fitting 128 includes a pressure fitting tip 150 that forces the shoulder 148 of the rod 126 into the throat 146 of the sensor bore 140 when the pressure fitting 128 is tightened within the sensor holder 142. Metal washers 152 and polymer washers 154 may be used to secure the rod 126 within the sensor bore 140 in a manner that prevents high pressure fluids and solids from passing through the sensor bore 140. The sensor holder 142 optionally includes a drain 156 to allow any fluids that bypass the connection between the rod 126, the sensor holder 142 and the pressure fitting 128. In this way, the pressure fitting 128, rod 126 and sensor holder 142 cooperate to retain the rod 126 within the sensor bore 140 in a manner that substantially isolates the rod 126 from contact with the vessel side wall 144 while preventing high pressure fluids and solids from escaping the sand separator 100.

The vibration sensor 132 is also coupled to the proximal end of the rod 126 and is configured to measure and report the frequency of vibrations in the rod 126. The vibration sensor 132 can be a piezo-electric sensor that produces a vibration signal in response to vibrations in the rod 126. In some embodiments, the exciter 130 and vibration sensor 132 are combined into a single component. The exciter 130 and vibration sensor 132 are connected by a wired or wireless connection to the solid separator control system 122. The solid separator control system 122 includes one or more sensor processors 158 that are configured to interpret the solids level data produced by each exciter 130 and the vibration sensor 132, correlate the solids level data with conditions in the solids tank 112, and coordinate with the solid separator control system 122 to apply responsive command signals to the vibratory level sensors 124 and other equipment or devices within the sand separator 100.

In operation, the vibratory level sensor 124 evaluates the presence and extent of solids trapped in the sand separator 100 by applying a vibration of known frequency (or energy) to the rod 126 with the exciter 130 and measuring the resulting responsive vibrations in the rod 126 with the vibration sensor 132. As accumulating solids in the sand separator 100 surround the distal end of the rod 126, the weight of the solid particles will cause the frequencies measured by the vibration sensor 132 to change due to the mass dampening phenomenon.

The change in the vibrations measured by the vibration sensor 132 can be compared by the sensor processor 158 within the solid separator control system 122 against the baseline vibration and a preexisting data library to determine the amount of solids around the vibratory level sensor 124. The data library includes correlations between vibration frequency changes and the amount of solid particles surrounding the rod 126. The data library can be stored within the solid separator control system 122 and can be compiled using empirical data obtained from controlled tests and live production data. In some embodiments, the solid separator control system 122 uses machine learning and neural networks to better identify patterns, signatures, and correlations between the measurements made by the vibratory level sensor 124 and the amount of solids in the sand separator 100. As an alternative to the preexisting signatures stored in the data library, the solid separator control system 122 can also determine the volume of solids in the sand separator 100 by applying adaptive algorithms to the measurements taken by the vibratory level sensor 124.

In a first mode of operation, the vibratory level sensor 124 determines the presence and extent of solids in the sand separator 100 by applying an initial vibration frequency to the rod 126 with the exciter 130 operating at a known energy and identifying a decrease in the frequency of the responsive vibration measured by the vibration sensor 132. In the example depicted in FIG. 6, the measured vibration shifted from about 353.81 Hz to about 332.43 Hz over a span of about 170 seconds, which signaled the transition from the rod 126 being immersed in a primarily liquid phase to an immersion of the rod 126 in a slurry of solids.

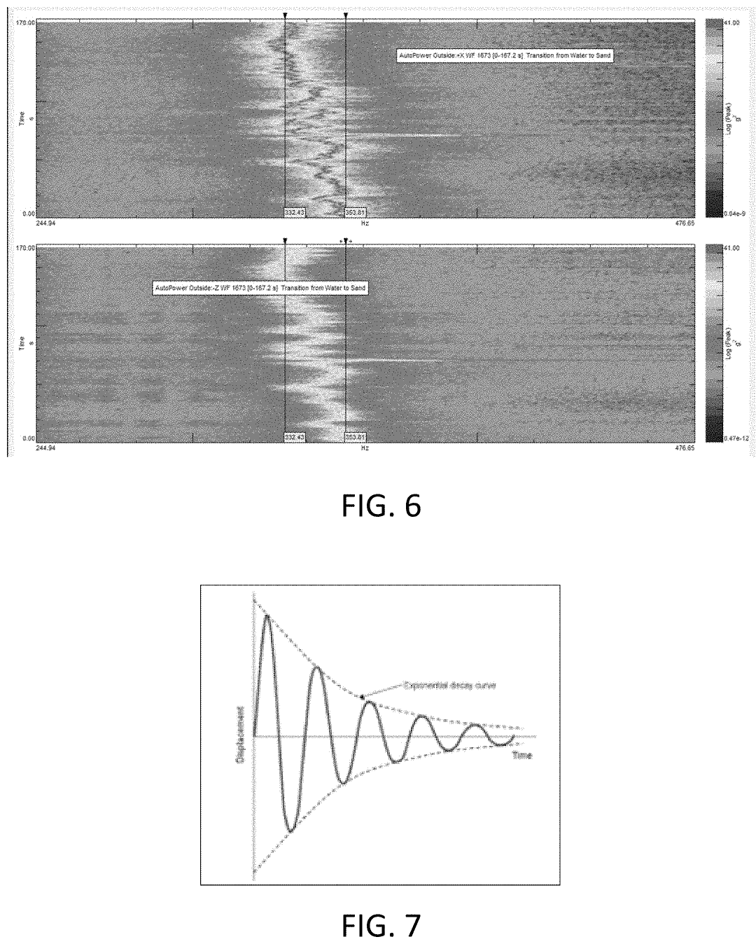

In a second mode of operation, the vibratory level sensor 124 determines the presence and extent of solids in the sand separator 100 by evaluating the attenuation or damping rate of vibrations within the rod 126. As depicted in FIG. 7, in this mode of operation, a known vibratory frequency is induced by the exciter 130 into the rod 126. Once the rod 126 is vibrating at the desired frequency, the exciter 130 is deactivated. The vibration sensor 132 monitors the rate at which the vibrations in the rod 126 attenuate or dampen over a set span of time or between set frequency limits. Because the presence and extent of solids in the sand separator 100 or in contact with the rod 126 affects the rate of attenuation in accordance with an exponential relationship, the rate of attenuation can be used as the basis for determining the amount of solids in the sand separator 100. As the weight of solids acting on the rod 126 increases, the damping rate also increases.

It will be appreciated that a given vibratory level sensor 124 can be switched between both modes of operation. In some embodiments, the sand separator 100 includes multiple vibratory level sensors 124 that are each operated in one or both modes of operation. As depicted in FIG. 2, the sand separator 100 may include multiple vibratory level sensors 124 disposed at different depths and positional orientations within the sand separator 100 to provide measurements of the level of solids throughout the sand separator 100.

Unlike prior art sand level sensors that merely indicate the presence of solids in direct contact with the level sensor, the vibratory level sensor 124 is capable of determining the weight or volume of solids throughout the area of the sand separator 100 in which solids settle and accumulate. As solids accumulate in the sand separator 100, the solids impact the response of the vibratory level sensor 124 even if the solids are not in direct contact with the vibratory level sensor 124. The response measured by the vibration sensor 132 is continuous rather than discrete and the response changes as solids accumulate in the sand separator 100. The total volume of accumulated solids impacting the vibratory response of the vibratory level sensor 124 can be compared against known response signatures to determine the total quantity, density and compaction of solids impacting the response of the vibratory level sensor 124. Thus, the total volume of solids in the sand separator 100 can be determined by one or more strategically placed vibratory level sensors 124 without relying on discrete or binary sensors placed at multiple depths within the sand separator 100.

The vibratory level sensor 124 and data library can be expanded to predict the type and size of solids in the sand separator 100. Small solid particles that are tightly packed around the distal end of the rod 126 will present a different frequency response than large, loosely packed particles. By comparing the vibration shift and attenuation measurements against the corresponding signatures of known solids in the data library, the sensor processor 158 can determine both quantitative (e.g., volume, weight) and qualitative (e.g., type, size) characteristics of solid particles in the sand separator 100.

In yet another embodiment, the vibratory level sensor 124 can be used to estimate the rate at which sand or other solid particles are produced from the well 106. In this mode of operation, the solid separator control system 122 is configured to determine the volume of solids accumulated in the sand separator 100 over a set or variable period of time. Using the known sample period and the measured volume of solids accumulating over that period, the solid separator control system 122 can calculate in near real-time the inflow rate at which the sand or other solids are flowing from the well 106 to the sand separator 100. The rates at which solids are produced from the well 106 can be used as additional inputs to optimize the production of hydrocarbons from the well 106. For example, if the inflow rate of sand to the sand separator 100 is too high, the solid separator control system 122 can be configured to reduce the flow out of the wellhead 102 by partially or completely closing the choke 114.

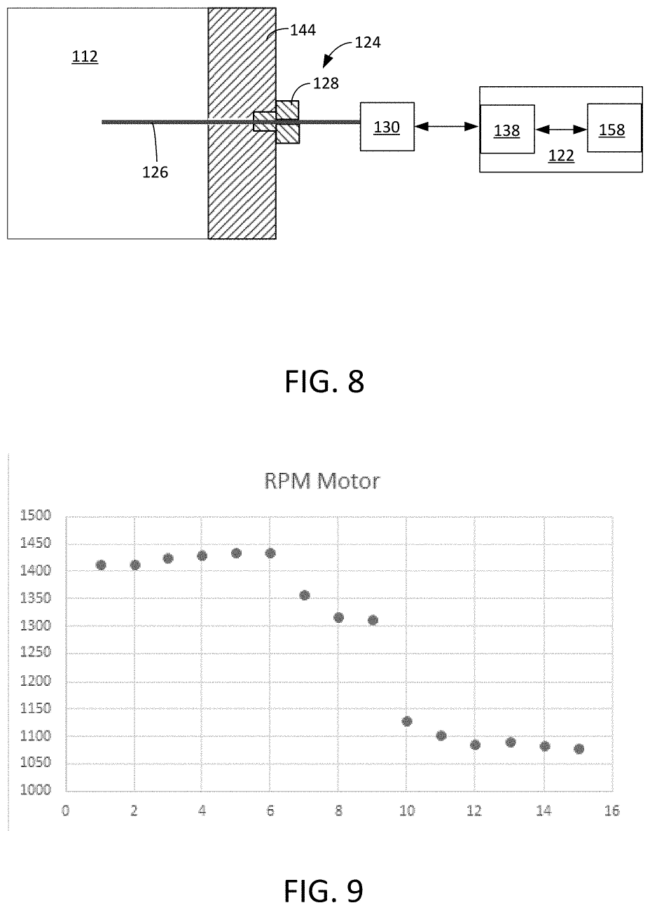

Turning to FIGS. 8-9, shown therein is an additional embodiment in which the vibratory level sensor 124 does not include, or does not rely upon, the vibration sensor 132. As with the embodiments depicted in FIGS. 3-5, the exciter 130 includes a motor 134 that is connected to an eccentric mass 136. When activated in response to a command signal from the motor controller 138, the motor 134 cause the eccentric mass 136 to spin, which produces a vibration at a selected frequency. In addition to providing the electrical signal to drive the motor 134, the motor controller 138 also monitors and reports the rotational speed of the motor 134 to the solid separator control system 122. The rotational speed of the motor 134 can be determined through a dedicated pulse counter or similar device that is integrated within the motor 134 or the motor controller 138. The output from the motor 134 or motor controller 138 is provided to the sensor processor 158 for processing.

In this embodiment, the vibratory level sensor 124 evaluates the presence and extent of solids trapped in the sand separator 100 by inducing an initial vibration frequency through the application of a drive signal to the motor 134 of known power (P) and rotational speed (ω). With respect to the motor 134, power consumption is product of Torque (T) and RPM (ω):

P=Tω

T=P/ω

Accumulating solids in the sand separator 100 will surround the distal end of the rod 126 and the weight of the solid particles will cause the vibrational frequency to change due to the mass dampening phenomenon. As the mass dampening becomes more quantitatively significant, more torque must be applied by the exciter 130 to the dampened rod 126. As torque requirements increase, the rotational speed (ω) of the motor 134 and eccentric mass 136 will decrease, while the power (P) consumption increases.

The effects of the mass dampening phenomenon are illustrated in FIG. 9. The motor 134 was initially rotating at speeds of between about 1400-1450 revolutions per minute (RPM). As the solids begin to dampen the vibration of the rod 126 (between about 6 and 10 gallons within the solids tank 112), the rotational speed of the motor 134 and eccentric mass 136 drop to a speed of between about 1050 and 1150 revolutions per minute. The dramatic reduction in the speed of the motor 134 is interpreted by the sensor processor 158 and solid separator control system 122 as an indication that the sand separator 100 has trapped solids in a volume up to the level where the sensor 124 is deployed within the solids tank 112.

These changes are monitored by the sensor processor 158 and correlated against a library of similar changes to determine the extent solids have accumulated around the distal end of the rod 126. A data library is developed using empirically-derived correlations between changes to the volume of solids around the rod 126 and changes to the torque (T), power (P), and rotational speed (ω) of the motor 134. The data library can be stored within the solid separator control system 122 and can be compiled using empirical data obtained from controlled tests and live production data. During use, the reduction in motor speed and the increase in power consumption can be compared (separately or together) against the preexisting data library to determine the quantity of solids surrounding the distal end of the rod 126. Thus, the operational characteristics of the motor 134 (torque, power and speed) can be evaluated to determine the extent of mass damping of the rod 126 to determine the extent to which solids are accumulating within the solids tank 112.

It will be appreciated that the foregoing method of determining the quantity and quality of solids inside the solids tank 112 based on changes to the inputs to the motor 134 can be used in embodiments where the vibration sensor 132 is present. In these embodiments, the sensor processor 158 can be configured to take measurements and make correlations based on feedback from both the vibration sensor 132 and the motor 134, either simultaneously or in an alternating fashion. The information received from the motor 134 and vibration sensor 132 can be used for confirmatory and differential determinations to more accurately and rapidly determine the quantities and qualities of solids trapped within the solids tank 112.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A system for determining the level of solids accumulated in a sand separator, the system comprising:
a vibratory level sensor, wherein the vibratory level sensor comprises:
a vibratory rod that extends into the sand separator such that distal portion of the vibratory rod is located inside the sand separator while a proximal portion of the vibratory rod is located outside the sand separator;
an exciter connected to the proximal portion of the vibratory rod, wherein the exciter is configured to induce a vibration in the vibratory rod; and
a vibration sensor connected to the proximal portion of the vibratory rod, wherein the vibration sensor produces a rod vibration signal based on the vibration of the vibratory rod; and
a sensor processor, wherein the sensor processor is configured to interpret the rod vibration signal and output an indication of the extent of solids in contact with the distal portion of the vibratory rod.

2. The system of claim 1, wherein the sensor processor is configured to interpret the rod vibration signal by detecting a shift in the frequency of the rod vibration signal.

3. The system of claim 1, wherein the sensor processor is configured to interpret the rod vibration signal by measuring a rate of attenuation of the vibration in the vibratory rod.

4. The system of claim 1, wherein the exciter comprises:
a motor;
a motor controller configured to apply a drive signal to the motor, wherein the drive signal applies an initial power to operate the motor at a preset rotational speed; and
an eccentric mass rotated by the motor in response to the drive signal from the motor controller.

5. The system of claim 4, wherein the sensor processor is configured to measure deviations from the initial power applied by the motor controller to the motor to maintain the preset rotational speed as solids accumulate around the distal portion of the vibratory rod.

6. The system of claim 1, wherein the sand separator comprises:
a sensor bore; and
a pressure fitting configured to retain the vibratory rod within the sensor bore while maintaining pressure inside the sand separator.

7. The system of claim 6, wherein the vibratory rod extends through the sand separator at a declining angle such that the distal portion of the vibratory rod is lower than the proximal portion of the vibratory rod.

8. A system for determining the level of solids accumulated in a sand separator, the system comprising:
a vibratory level sensor, wherein the vibratory level sensor comprises:
a vibratory rod that extends into the sand separator such that distal portion of the vibratory rod is located inside the sand separator while a proximal portion of the vibratory rod is located outside the sand separator;
an exciter connected to the proximal portion of the vibratory rod, wherein the exciter is configured to induce a vibration in the vibratory rod; and wherein the exciter comprises:
a motor coupled to the proximal portion of the vibratory rod; and
an eccentric mass rotated by the motor in response to the drive signal from the motor controller;
a motor controller configured to apply a drive signal to the motor to place the motor in an operating state, wherein the drive signal applies a preset amount of power to operate the motor at a preset motor rotational speed; and
a sensor processor, wherein the sensor processor is configured to correlate changes in the operating state of the motor with an accumulation of solids around the distal portion of the vibratory rod.

9. The system of claim 8, wherein the sensor processor is configured to correlate a reduction in the motor rotational speed with an accumulation of solids around the distal portion of the vibratory rod.

10. The system of claim 8, wherein the sensor processor is configured to correlate an increase in the power applied by the motor controller to the motor to maintain the motor at the preset motor rotational speed with an accumulation of solids around the distal portion of the vibratory rod.

11. The system of claim 8, wherein the vibratory level sensor further comprises a vibration sensor connected to the proximal portion of the vibratory rod, wherein the vibration sensor produces a rod vibration signal based on the vibration of the vibratory rod.

12. The system of claim 11, wherein the sensor processor is further configured to interpret the rod vibration signal by detecting a shift in the frequency of the rod vibration signal.

13. The system of claim 11, wherein the sensor processor is configured to interpret the rod vibration signal by measuring a rate of attenuation of the vibration in the vibratory rod.

14. The system of claim 8, wherein the sand separator comprises:
a sensor bore; and
a pressure fitting configured to retain the vibratory rod within the sensor bore while maintaining pressure inside the sand separator.

15. The system of claim 14, wherein the vibratory rod extends through the sand separator at a declining angle such that the distal portion of the vibratory rod is lower than the proximal portion of the vibratory rod.

16. The system of claim 8, wherein the sand separator comprises a plurality of vibratory level sensors.

17. A method for determining the level of accumulated solids within a separator that includes a vibratory level sensor that has a vibratory rod that extends into the separator such that a distal portion of the vibratory rod is inside the separator and a proximal portion of the vibratory rod is outside the separator, the method comprising the steps of:
providing a pressurized slurry of solids and fluids to the separator;
activating an exciter coupled to the proximal portion of the vibratory rod to induce a vibration in the vibratory rod with an initial frequency;
separating the solids from the fluids inside the separator such that the solids settle toward the bottom of the separator in contact with the vibratory rod;
monitoring the operational state of the vibratory level sensor; and
correlating a change in the operational state of the vibratory level sensor with a determination of the extent to which solids have accumulated around the distal portion of the vibratory rod.

18. The method of claim 17, wherein the step of monitoring the operational state of the vibratory level sensor comprises monitoring a shift in the frequency of the vibration of the vibratory rod and the step of correlating a change in the operational state of the vibratory level sensor comprises correlating the shift in the frequency of the vibration of the vibratory rod with an increased accumulation of solids around the distal portion of the vibratory rod.

19. The method of claim 17, wherein the step of monitoring the operational state of the vibratory level sensor comprises monitoring a rate of attenuation in the vibration of the vibratory rod and the step of correlating a change in the operational state of the vibratory level sensor comprises correlating the rate of attenuation in the vibration of the vibratory rod with an increased accumulation of solids around the distal portion of the vibratory rod.

20. The method of claim 17, wherein the step of monitoring the operational state of the vibratory level sensor comprises monitoring an increase in the consumption of power by the exciter with an increased accumulation of solids around the distal portion of the vibratory rod.
